(19) United States
(12) Patent Application Publication
(10) Pub. No.: US 2003/0051172 A1
(43) Pub. Date: Mar. 13, 2003

(54) Method and system for protecting digital objects distributed over a network

(76) Inventors: David A. Lordemann, Los Altos, CA (US); Daniel J. Robinson, Santa Clara, CA (US); Paul O. Scheibe, Woodside, CA (US)

Correspondence Address: SCHNECK & SCHNECK, P.O. BOX 2-E, SAN JOSE, CA, 95109-0005, US

(21) Appl. No.: 10/279,378

(22) Filed: Oct. 23, 2002

Related U.S. Application Data
(63) Continuation-in-part of application No. 09/952,290, filed on Sep. 13, 2001.

(51) Int. Cl. H04L 9/00

(52) U.S. Cl. 713/201

(57) ABSTRACT

A method and system for protecting objects stored on network servers are presented. An object server runs computer software that designates which objects are to be protected and the security policy for that object. If the object server receives a request for a protected object, the object server creates an enhanced request containing cryptographically protected data related to the request and to the requested object; this enhanced request is redirected to a security server. The security server authenticates the request, retrieves the requested object from the object server, a file server associated with the security server, or a local cache, encrypts the object, and combines the encrypted object with mobile code, the security policy, and object controls to implement the policy. This package is then sent to the requester, which executes the mobile code, resulting in the installation of the security policy and object controls on the requester computer. The requested object is rendered subject to the security policy and object controls. The security server maintains a logfile of actions taken on the object. This logfile can be used to create an audit trail for the object.

### CROSS-REFERENCE TO RELATED APPLICATION

This application is a continuation-in-part of application Ser. No. 09/952,290, filed Sep. 13, 2001, entitled “Method and System for Protecting Objects Distributed Over a Network.”

### FIELD OF THE INVENTION

This invention is related to a method and system for protecting digital objects such as code, documents, and images that are distributed over a network.

### BACKGROUND OF THE INVENTION

The Internet is now commonly used in the course of business to search for information and exchange code, documents, images, etc. among collaborators, prospective business partners, and customers. The increase in business conducted on the Internet has been accompanied by an increasing concern about protecting information stored or communicated on the Internet from “hackers” who can gain unauthorized access to this information and either use it for their own financial benefit or compromise the information or the system on which it is stored. Given the enormous volume of business conducted on the Internet and the corresponding value of that business, it is imperative that the objects (including code, documents and images—anything represented in digital form) that are stored and exchanged and the intellectual property contained within those objects are secure—i.e., they cannot be accessed by individuals or companies who have no right to them, they cannot be printed unless there is permission to do so, they cannot be edited except where that right has been conferred by the owner.

Protection of objects and object exchanges may have many components. One of these, authentication, is the process of verifying the identity of a party requesting or sending information. This is generally accomplished through the use of passwords. A drawback to this approach is that passwords can be lost, revealed, or stolen.

A stricter authentication process uses digital certificates authorized by a certificate authority. A digital certificate contains the owner's name, serial number, expiration dates, and the digital signature (data appended to a message identifying and authenticating sender and message data using public key encryption (see below)) of the issuing authority. The certificate also contains the certificate owner's public key. In public key cryptography, which is widely used in authentication procedures, individuals have public keys and private keys which are created simultaneously by the certificate authority using an algorithm such as RSA. The public key is published in one or more directories containing the certificates; the private key remains secret. Messages are encrypted using the recipient's public key, which the sender captures in a directory, and decrypted using the recipient's private key. To authenticate a message, a sender can encrypt a message using the sender's private key; the recipient can verify the sender's identity by decrypting the signature with the sender's public key.

Authorization determines whether a user has any privileges (viewing, modifying, etc.) with regard to a resource. For instance, a system administrator can determine which users have access to a system and what privileges each user has within the system (i.e., access to certain files, amount of storage space, etc.). Authorization is usually performed after authentication. In other words, if a user requests access to an object, the system will first verify or authenticate the identity of the user and then determine whether that user has the right to access the object and how that user may use the object.

Encryption may also be used to protect objects. Encryption converts a message's plaintext into ciphertext. In order to render an encrypted object, the recipient must also obtain the correct decryption key (see, for instance, the discussion of the public key infrastructure and public key cryptography above). Although it is sometimes possible to “break” the cipher used to encrypt an object, in general, the more complex the encryption, the harder it is to break the cipher without the decryption key. A “strong” cryptosystem has a large range of possible keys which makes it almost impossible to break the cipher by trying all possible keys. A strong cryptosystem is also immune from previously known methods of code breaking and will appear random to all standard statistical tests.

Other types of security to protect the entire computer system may also be employed at the computer locations. For instance, many businesses set up firewalls in an attempt to prevent unauthorized users from accessing the business' data or programs. However, firewalls can be compromised and do not guarantee that a computer system will be safe from attack. Another problem is that firewalls do not protect the system or the system's resources from being compromised by a hostile user located behind the firewall.

Transmission of messages can also be secured. Transport Layer Security (TLS) and Secure Sockets Layer (SSL) protocols are commonly used to provide encrypted communications between servers and clients. Both these protocols are incorporated into most Web browsers and servers.

Audit trails provide protection for an object by enforcing accountability, i.e., tracing a user's activities which are either related to an object (such as a request for the object) or actually performed on an object (viewing, editing, printing, etc.) which has been transmitted. Audit trails must be secure from unauthorized alterations; for instance, unauthorized users cannot be allowed to remove evidence of their activities from an audit log. Auditing requests and actions generates a huge amount of information; therefore, any system generating audit trails must have the capability to store the information and process it efficiently.

The above-mentioned security devices may be used separately, or more commonly, in some combination. In addition to these general devices, there are other approaches to security in the prior art.

InterTrust Technologies Corporation has received several patents related to their digital rights management technology. InterTrust's Digibox container technology enables the encryption and storage of information, including content and rules regarding access to that content, in a Digibox container, essentially a software container. The container, along with the encryption keys, is passed from node to node in a Virtual Distribution Environment (VDE). The VDE consists of dedicated hardware or software or combination thereof. Information in the containers may only be viewed by devices incorporated in a VDE which run the appropriate Intertrust software. An audit trail may be generated, stored, and viewed within the VDE.

There is a need for an invention that will protect objects (basically, anything which may be represented in digital form), including code, documents, images, and software programs, that are available on the Internet without requiring authorized requesters to run special software on their computers in order to access protected information; a secure audit trail to ensure accountability and non-refutability is also desirable. It is also desirable to pass the protection duties, including storing the audit trail, to a third party in order to relieve the object server of both the processing and hardware burden of providing the security (including having enough memory to store a voluminous audit trail). Finally, it would be desirable to store information such as the request, authentication, authorization, serialization of the requested object, nonce of the requested object, security policy of the requested object, and a description of the protected object in the audit trail to provide comprehensive protection and demonstrate the integrity and irrefutability of the audit trail.

There is a need for a security approach for data that will protect objects, including code, documents, images, and software programs, that are available on the Internet without requiring authorized requesters to run special software on their computers in order to access protected information. (For instance, students are often on a limited budget and, even if they have their own computers, cannot reasonably be expected to buy extra software which would enable them to download information like course notes, schedules, etc. that schools are increasingly making available to authorized users over the Internet.) Additional desirable features for a digital rights management system include passing most of the protection “duties” to a third party in order to relieve the object server of the processing burden of providing security and providing one-time encryption keys that are securely passed between the requester and the “security server” rather than passing the encryption keys with the encrypted data. It is also desirable for a digital rights management system to offer protection to an object even after the object has been sent to the requester.

### SUMMARY OF THE INVENTION

This invention provides a method and system for protecting objects by restricting certain operations (i.e., viewing, printing, editing, copying) on the objects by certain recipients.

An object server containing objects, both protected and unprotected, is equipped with software that designates whether an object should be protected and, if so, what the security policy (type and degree of protection the object should receive) is. The security policy may include restrictions on who may view the object, the lifetime of the object, the number of times the object may be viewed, as well as provisions, or actions policies, granting the requester the right to print, edit, etc. Object controls are mechanisms which implement the security policy.

When the object server receives a request for an object, the software checks whether the requested object is protected. If the object is unprotected, the server will send the object to the requester. If the object is protected, the software creates a new object which includes authentication and time of the original request as well as serialization, nonce, security policy, and description of the requested object; all of these are bound together cryptographically to prevent alteration and to provide for the authentication of the object server. The new object is sent back to the requesting browser in a reply, along with a redirect command that points the requesting browser to a “security server.”

After the security server, which is equipped with software for providing protection services, receives and authenticates the redirected request, it obtains the requested object either from its own local cache or local file server or from the object server containing the object via a secure transmission. The security server then encrypts the requested object (using strong and nonmalleable encryption) and combines it with mobile code (software sent from remote systems, transferred across a network, and downloaded and executed on a local system without explicit installation or execution by the recipient), the security policy, and object controls. This resulting package is sent back to the requesting computer as a reply to the redirected request.

The requesting computer then tries to execute the mobile code in order to render the requested object. The mobile code will execute tests to ensure proper instantiation of the object controls; when these controls are properly instantiated, the requester may request a decryption key which is sent via secure transmission to the requester upon satisfactory authentication of the request. The decryption keys may be one-time keys which may be used only for decrypting the specific object in question; in other embodiments, the same key may be delivered to all requesters requesting the same object or some other entity may encrypt the document. If the mobile code executes successfully and a decryption key is obtained, the requested object is rendered subject to the constraints of the security policy and object controls.

A descriptor of any actions involving the security server and the requestor's activities with regard to the object is recorded in a logfile available for review by authorized individuals such as the security server's system administrator and the content owner. This logfile, which may be a flat file, files distributed across various platforms, or embodied in a database, tape drives, line printer, or any combination thereof, may be used to construct an audit trail detailing who requested which objects, whether the objects were delivered, what type of security policy was in place for each of these objects and any actions taken on the object by the requester, as well as derived information such as the time an object was accessed, the number of times an object was accessed, etc.

The security server is used to execute most of the activities associated with protecting and delivering the requested object. Therefore, the object server is not spending processing resources on security issues and instead is dedicated to handling requests for information. In addition, all set-up time and maintenance for the security server is handled by that server's system administrators, resulting in further savings to the owners of the object servers.

This method and system differ from other object protection methods and systems in that common software does not need to be installed on all computers involved in the request and provision of a requested object. In addition, in one embodiment, the keys used to encrypt the object are one-time keys and are not passed with the encrypted object.

### BRIEF DESCRIPTION OF THE DRAWINGS

FIG. 1 is a block diagram of the components of an object protection system in accordance with the invention.

FIG. 2a is a flow chart showing how an object is protected in accordance with the invention.

FIG. 2b is a flow chart showing how an object is protected in accordance with the invention.

FIG. 3 is a block diagram of the components in an object protection system in another embodiment of the invention.

FIG. 4a is a flow chart showing how a logfile of requestor's activities on a protected object is created in accordance with the invention.

FIG. 4b is a flow chart showing how a logfile of security server activities is created in accordance with the invention.

### DETAILED DESCRIPTION OF THE INVENTION

Application Ser. No. 09/952,290, filed Sep. 13, 2001 by Lordemann et al. is hereby incorporated by reference. A related application by Lordemann et al., Ser. No. 09/952,696, filed Sep. 14, 2001 is also hereby incorporated by reference.

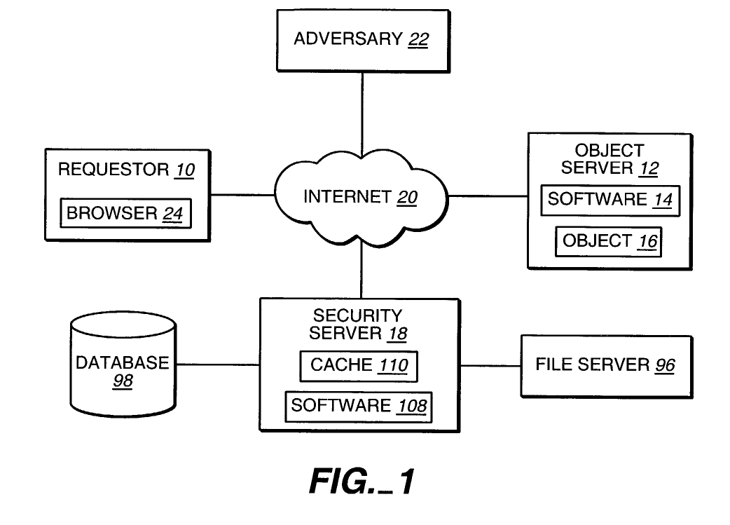

With reference to FIG. 1, a requester device 10 (in this embodiment, the device is a computer; however, the term “device” includes anything that can act as a client in a client/server relationship), an object server 12, containing objects 16 and protection software 14 which designates whether objects are to be protected, and a security server 18 containing software 108 for providing protection services and a cache 110 are all connected to a network, in this embodiment, the Internet 20. An object 16 includes anything which may be represented in digital form, such as code, a document, an image, a software program, etc. (Although the singular term “object” is employed throughout this discussion, the term encompasses both a single object or any aggregation of two or more objects.) An adversary 22, a person or device such as a computer or recorder which may be used to gain unauthorized access to a protected object, may also be present. Although a single requestor device 10, object server 12, and security server 18 are discussed here, it is envisioned that this method and system will accommodate a plurality of requestor devices 10, object servers 12, and security servers 18. The security server 18 may be a single machine or a collection of machines performing different or similar functions.

In this embodiment, the object server 12 and the security server 18 are Hypertext Transfer Protocol (http) servers. The requester device 10 should be running a software program acting as a World Wide Web browser 24. Requests for objects 16 from the requester device 10 are relayed by the browser 24 to the object server 12 via http requests. Similarly, replies to requests conform to the http protocol.

As noted above, the object server 12 is running protection software 14, which in this embodiment is an extension of http server software. This protection software 14 is used by an authorized system administrator to designate which objects 16 are unprotected and which are to be protected. If an object 16 is designated as protected, the protection software 14 also allows the administrator to specify the type and degree of protection (i.e., the security policy) for the object 16. The security policy may include restrictions on who may view the object, the lifetime of the object (i.e., temporal restrictions), the number of times the object may be viewed (i.e., cardinal restrictions), as well as actions policies relating to whether the object may be printed, edited, etc. The actions that the requester may perform on an object may vary depending on the identity of the requestor. Object controls are mechanisms which implement the security policy.

The security server 18 is also running software 108 which is an extension of http server software. This software 108 provides the protection services for objects. The security server 18 is capable of processing an aggregation of objects, for instance, combining an HTML file and its inclusions into a single protected object. A file server 96 may be in network connection with the security server 18. A database 98, either stored at the security server 18 or an another device in network connection with the security server 18 may also be present. The security server 18 also has a local cache 110 for storage.

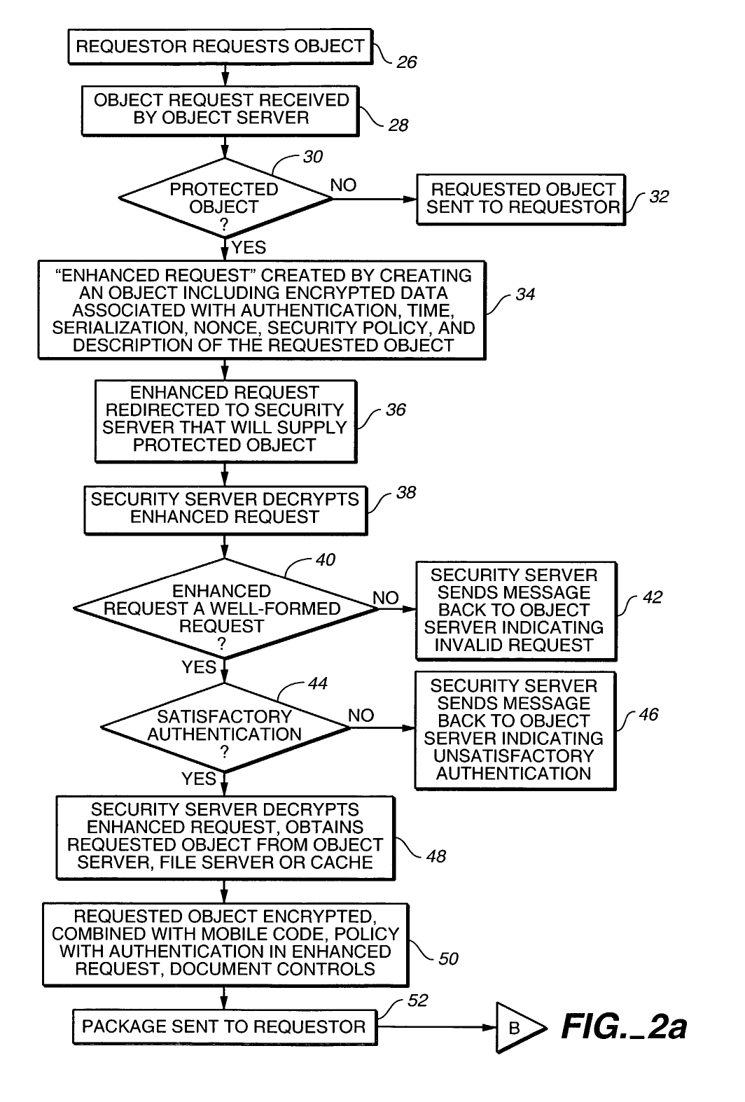

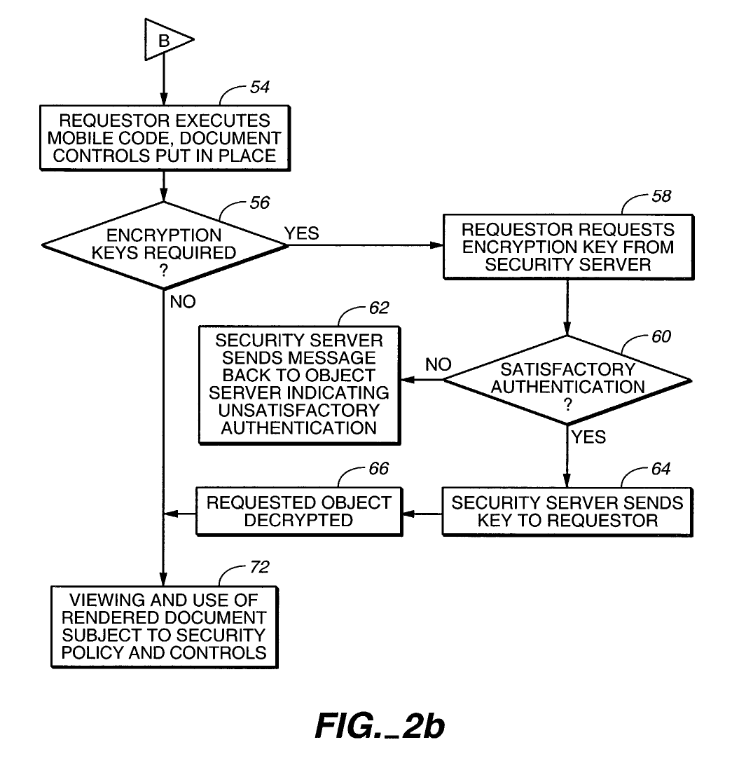

In FIG. 2a, a requester requests an object (block 26). The object server storing the requested object receives the request (block 28). If the object server has an independent authentication policy, the object server will execute that policy and authenticate the request upon receipt. The protection software examines the http request to determine whether the request is for a protected object (block 30). If the requested object is not protected, the requested object is sent to the requester (block 32).

However, if the object is protected (block 30), the protection software creates an enhanced request (block 34) that is included in a reply to the request and is subsequently redirected to the security server (block 36). The enhanced request is an object comprising cryptographically-protected data including authentication and time of the original request as well as serialization (ensuring only one approved version of an object is available), nonce, security policy, and a description of the requested object bound together to prevent alteration and to provide for authentication of the object server. (Information about authentication depends on whether the object server has an independent authentication policy. If there is an authentication policy, the enhanced request includes the result of the authentication. If there is no authentication policy, that information is also included in the enhanced request.)

Cryptographic protection provides a variety of services. It can protect the integrity of a file (i.e., prevent unauthorized alterations) as well as assisting with the authentication and authorization of a request. The use of cryptographic protection here can also protect the privacy of the requester. Other uses for cryptographic protection include non-repudiation and detecting alterations. Cryptographic protection includes encryption. Protocols supporting both strong and non-malleable encryption are used. (Protocols determine the type of encryption used and whether any exchanges between the requester and security server are necessary before decryption takes place (for example, a key may need to be exchanged so the recipient can decrypt an object encrypted at the server).)

The enhanced request is included in the reply to the requester along with a command to redirect the request to the security server. This redirection should be transparent to the requester.

The security server software processes the enhanced request (block 38). A shared key for cryptographically protecting the enhanced request is present at the object server and the security server. The key is instantiated when the software is installed on the object server. In one embodiment, the key is generated when the software is installed on the object server. In other embodiments, the security server generates the key or the key may come from a certificate purchased from a third party.

The security server software then checks whether the enhanced request meets the requirements for a well-formed request (block 40). In one embodiment, if the requirements for a well-formed request are not met, the security server sends a message back to the object server indicating an invalid request (block 42). (The object server may then send a message to the requestor about the invalid request. The system administrator for the object server determines whether these messages will be sent.) In other embodiments, the security server does not send a message indicating an invalid request. Whether a message is sent in an option set by a system administrator.

If the request is valid, the security server software next authenticates the request (block 44). The security server software will compare the time and authentication in the redirected request heading with those contained in the enhanced request. If the security server software cannot authenticate the request (for instance, the two request times differ such that a replay attack is indicated or the identity of the requester in the redirected request differs from the identity of the requester in the enhanced request), a message is sent back to the object server indicating unsatisfactory authentication (block 46). If the request is authenticated, the security server software obtains the requested object either from the security server's cache, the object server, or a file server (block 48). (The protection software will pass the object on to the security server upon request.) If the security server has to obtain the object from the object server or the file server, the object is passed via a secure transmission.

Once the security server has the requested object, the security server software encrypts it using strong encryption and non-malleable encryption and combines the object with mobile code (software sent from remote systems, transferred across a network, and downloaded and executed on a local system without explicit installation or execution by the recipient), a security policy with authentication contained in the enhanced request, and object controls (block 50). Cryptographic protection of the requested protected object serves to protect the object, its requester, and the provider by ensuring integrity, privacy, authentication (where appropriate), and authorization as well as being a tool for non-repudiation (i.e., a party to a transaction cannot falsely deny involvement in that transaction) and detecting alterations. The resulting package is then sent to the requester (block 52; see block B, FIG. 2b).

In FIG. 2b, the requester receives the reply and attempts to execute the mobile code (block 54). Upon execution of the mobile code, the security policy and object controls for the requested object are instantiated on the requestor's computer (block 54). The mobile code executes tests to determine whether the object controls were correctly instantiated. If so, if the requestor needs a decryption key (block 56), the requester may request it from the security server (block 58). The security server software authenticates the request (block 60). If it cannot authenticate the request, a message to that effect is sent to the object server (block 62). However, if the message is authenticated, the security server software sends the requested key back to the requester (block 64) via a secure transmission, and the requested object is decrypted (block 66). In one embodiment, the key used by the security server to encrypt/decrypt the object is a one-time key. The onetime key is provided either by a “seed” for randomly generating the key which is determined at the installation of security server software or other means known in the prior art, the most common being certificates.

Once the mobile code is executed, the requester may view the object subject to any constraints imposed on the object by the security policy or object controls (block 68).

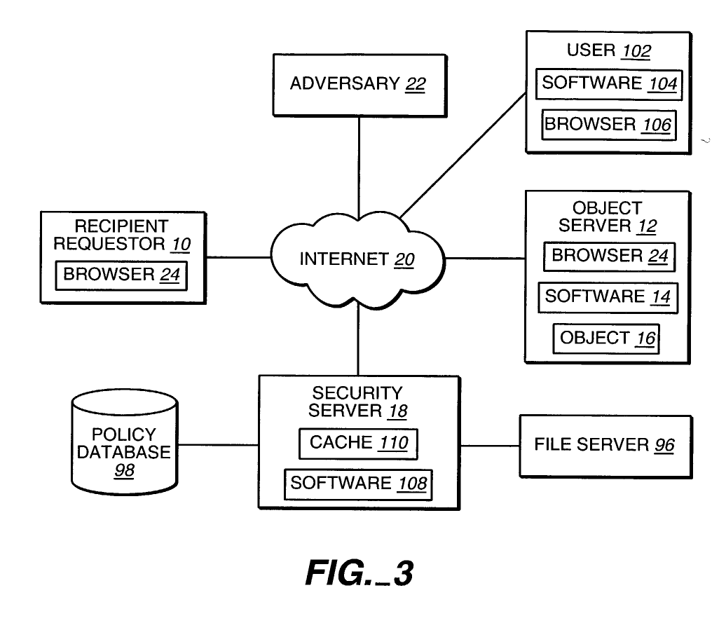

With respect to FIG. 3, in another embodiment of the invention, a user 102 can send a notification, via a Web browser, to the security server 18 to make an object 16, stored at the object server 12, available to a recipient, or requester, 10, for instance, for use at a meeting. (Although the following description will discuss notifying a recipient/requestor 10 about a single object 16, this process may be used to notify a recipient 10 of the availability of any number of objects. Similarly, although only one recipient 10 is discussed here, the notification can be sent to any number of recipients 10.) Here, the user device 102, which is running specialized software 104 for issuing the notification which is associated with a Web browser 106, sends a request to the security server 18, which is running security software 108, indicating what object 16 is to be made available, the security policy for this object 16 (this security policy temporarily overrides the security policy at the object server 12), and the recipient 10. After determining that the user 102 has the authority to allow access to the object 16 (i.e., authenticating the notification), the security server 18 extracts the security policy information and stores it in a policy database 98. The security server 18 also extracts any attachments and stores the attachments at an associated file server 96.

The security server 18, or an associated e-mail server, then sends an e-mail to the recipient 10 identified in the user's 102 notification. The e-mail informs the recipient 10 that an object 16 is available and may be obtained by referencing a URL associated with the object 16. (The URL is generated by the security server 18. Depending on the security policy set by the user 102, the available object 16 may only be viewed for a certain number of hours after the notification is sent, so the URL may be used to access the object 16 only for a finite period of time.) If the recipient 10 uses the URL to request the object 16 from the object server 12, the object server 12 redirects the request to the security server 18 (the redirected request acts as the enhanced request, described above). The security server 18 then retrieves the requested object 16, either from the object server 12 via a secure connection or from a local file server 96 or cache 110 if the object 16 has been handled previously by the security server 18. The security server 18 then protects (i.e., compresses, encrypts, etc.) the object 16 as discussed above, depending on the security policy specified for the object 16. The security server 18 then combines the object 16 with mobile code, as discussed above, and sends it to the recipient 10. Decryption keys, also combined with mobile code, may be sent in the same object session.

In another embodiment, a user at the object server 12 can send a notification, again via a Web browser 112, directly to a recipient/requestor 10(or any number of recipients/requestors 10) than an object 16 (or objects 16) stored at the object server 12 is available and may be obtained by referencing a URL (generated by object server 12 software 14) associated with the object 16. When the recipient/requestor 10 uses the URL to request the object 16 from the object server 12, the object server 12 redirects the request to the security server 18. The security server 18 then retrieves the requested object 16, either from the object server 12 via a secure connection or from a local file server 96 or cache 110 if the object 16 has been handled previously by the security server 18. The security server 18 then protects (i.e., compresses, encrypts, etc.) the object as discussed above, depending on the security policy specified for the object 16 at the object server 12. The security server 18 then combines the object with mobile code, as discussed above, and sends it to the recipient/requestor 10. Decryption keys, also combined with mobile code, may be sent in the same object session.

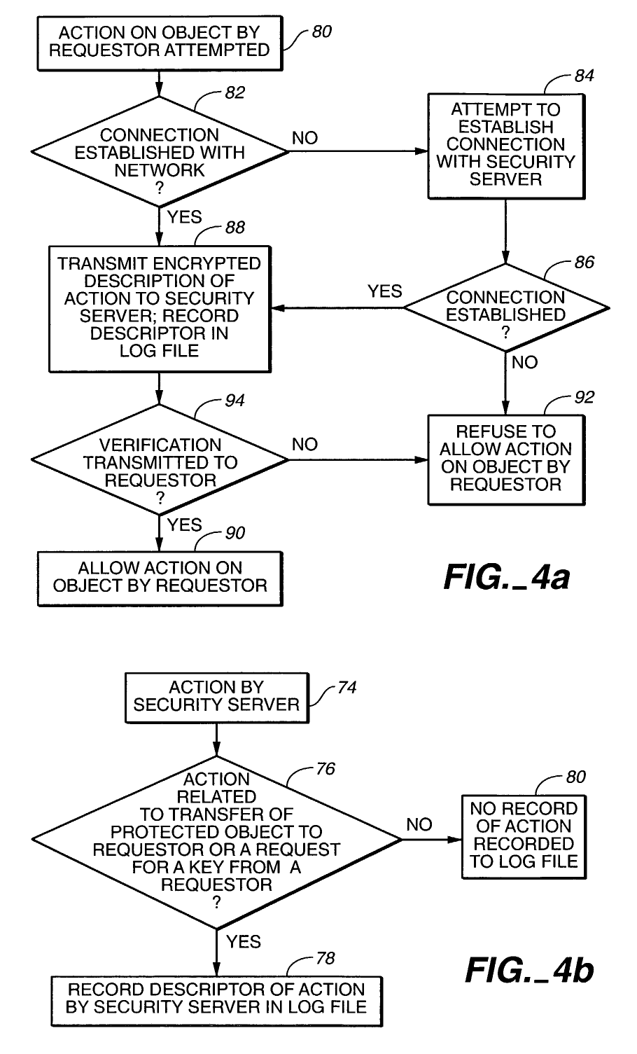

As shown in FIG. 4a, a logfile of actions taken on the object by the requester (and, as will be shown in FIG. 4b, actions taken by the security server) is maintained for the purpose of establishing an audit trail. The logfile, which may be a flat file, files distributed across various platforms, or embodied in a database, tape drives, line printer, or any combination thereof, is available for review by the security server's system administrator. The logfile may be used to construct an audit trail detailing who requested what objects, whether the objects were delivered, and what type of security policy was in place for each of these objects.

If the requestor attempts any action related to the object (i.e., viewing, printing, editing the object, etc.) (block 80), the object controls will determine whether there is an established connection to a network (block 82). If there is an open connection, an encrypted descriptor of the action will be transmitted to the security server, which will record the descriptor along with some other data in a logfile (block 88). The other material recorded to the logfile also includes “local data,” i.e., data present at the server including the local time and the identity of the server, time, and the requestor's network IP address. Once the information is transmitted to the security server and verification is transmitted to the requester (block 94), the action on the object is allowed (block 90). For instance, as discussed above, the requester may view the requested object only when the mobile code is successfully instantiated and a decryption key has been received from the security server. When the object is first viewed at the requestor's computer, a descriptor of this event, i.e., viewing the object, is sent to the security server. In another example, if the requester attempts to print the object, a description of this action is sent to the security server. If no authorization is transmitted to the requester (block 94), the requestor's request to perform an action on the object is denied (block 92).

If no secure established connection to the security server is present, the object controls will attempt to establish such a connection to the security server (step 84). If the connection is established (block 86), a cryptographically protected descriptor of the action will be transmitted to the security server, which will record the descriptor and the other data discussed above in a logfile (block 88). The action on the object may be allowed (block 90). However, if a connection cannot be established (block 86), the requestor's request to perform an action on the object is denied (block 92).

As shown in FIG. 4b, the security server also records to a logfile descriptors of any actions it takes with regard to a protected object. These actions include responding to requests for objects, sending the object to the requester, receiving requests for decryption keys, and sending a decryption key to the requester. When the security server performs an action (block 74), system software determines whether that action is related to the transfer of a protected object or a request for a decryption key (block 76). If the action is not related to the transfer of a protected object or a request for a decryption key, nothing is recorded to the logfile (block 80). However, when the action is related to either a protected object or a decryption key, a descriptor of the action, along with time, local data, and the network IP address of the requester, is recorded to a logfile (block 78). As an example, when the security server receives an enhanced request for a protected object, the security server saves the enhanced request to the logfile; along with the enhanced request, at least time, local data, and the network IP address of the requester are saved. When the security server sends the requester a package containing the object combined with mobile code, a record of this action is written to the logfile.

In another embodiment, the requester may take actions on the object while “untethered” (i.e., not connected to the security server). Provided the security policy allows untethered activity, the requestor's actions are recorded on the requester device and then sent to the security server when the requestor establishes a connection to the security server. Controls may be set such that access to the object is further restricted if a connection to a network is not established within a set time frame.

In another embodiment, the descriptors of the security server's actions may be cryptographically protected before they are written to the logfile. This embodiment may be used when persons other than the system administrator are allowed access to the logfile.

1. In a communications network, a system for protecting objects comprising:
a) an object server connected to the network, the object server running a first software program having instructions to be executed by the object server, said instructions including designating at least one object among a set of objects stored at the object server to be protected and determining a security policy for each protected object;
b) a requester device having means for requesting a protected object from the object server, the requester device connected to the network; and
c) a security server running a second software program providing protection services for objects designated by the first software program as protected objects, the security server connected to the network wherein the second software program has instructions to be executed by the security server for providing protection services, said instructions including:
i) obtaining the requested protected object from a storage location;
ii) combining the requested protected object with mobile code, a security policy, and object controls; and
iii) sending the requested protected object combined with mobile code, the security policy, and object controls to the requester device, wherein the mobile code instantiates the security policy and object controls for the requested protected object at the requester device upon receipt of the object such that the requested protected object may be accessed only in accordance with the security policy and object controls associated with the requested protected object.

2. The system of claim 1 wherein the security server further comprises means for receiving a redirected enhanced request for the requested protected object from the requester device, the enhanced request corresponding to the requestor's device's first request for the requested protected object, wherein the object server creates the enhanced request.

3. The system of claim 1 wherein the security server further comprises means for verifying proper instantiation of the object controls.

4. The system of claim 1 wherein the security server further comprises means for providing a decryption key to the requester computer upon verification of proper instantiation of the object controls and satisfactory authentication of a request from the requester device for the decryption key.

5. The system of claim 1 wherein the security server further comprises means for encrypting the requested protected object.

6. The system of claim 1 wherein the security server further comprises means for compressing the requested protected object before encrypting it.

7. The system of claim 1 wherein the security server further comprises means for recording to a logfile information about events, the events belonging to a group comprising:
a) requests for action on a requested protected object initiated by the requester device;
b) action taken on the protected object at the requester device; and
c) actions taken by the security server related to the protection of the requested protected object.

8. The system of claim 7 wherein the security server further comprises means for creating an audit trail from the information recorded to the logfile.

9. The system of claim 7 wherein the information recorded is time of the event.

10. The system of claim 7 wherein the information recorded is a network IP address of the requester device initiating the event.

11. The system of claim 7 wherein the information recorded to the logfile includes a descriptor of the event.

12. The system of claim 7 wherein the information recorded to the logfile includes a request sent to the security server.

13. The system of claim 7 wherein the information sent by the requester device to the security server is cryptographically protected according to a protocol.

14. The system of claim 7 further confirming means for establishing a connection between the requester device and the security server for recording information about requests for action initiated at the requester device, said connection to be established when there is no existing connection between said requester device and said security server.

15. The system of claim 14 further comprising means for refusing a requested action on the protected object if a connection between the requester device and the security server cannot be established.

16. The system of claim 7 further comprising means for an untethered requester device recording any actions on the requested protected object in a file on the requester device and means for sending the file to the security server when the requester device establishes a network connection to the security server.

17. The system of claim 1 wherein the storage location is one of a local file server, a local cache, or the object server.

18. The system of claim 1 wherein the object server further comprises:
a) means for sending a message to at least one recipient that at least one object stored at the object server which may be accessed by the at least one recipient, and
b) means for generating a URL corresponding to the at least one object stored at the object server and which may be accessed by the at least one recipient, wherein the generated URL is included in the message to the at least one recipient.

19. The system of claim 1 further comprising a sender device attached to the network, the sender device running a third software program associated with a browser at the sender device, said third software program comprising:
a) means for specifying at least one object stored at the object server which may be accessed by at least one recipient;
b) means for identifying a security policy for the at least one object, the security policy specified by the sender temporarily overriding any security policy identified by the first software program at the object server; and
c) means for sending a message to the security server to notify the at least one recipient that the specified at least one object may be accessed.

20. The system of claim 19 wherein the security server comprises means for generating a URL corresponding to the at least one object stored at the object server.

21. The system of claim 20 wherein the security server further comprises means for sending an e-mail to at least one identified recipient, said e-mail identifying the at least one object which may be accessed and including each generated URL corresponding to the at least one object stored at the object server.

22. The system of claim 19 wherein the security server further comprises means for authenticating the message from the sending device.

23. In a communications network, a method for protecting objects comprising:
a) receiving a request from a requestor device at an object server for a protected object;
b) redirecting the request to a security server;
c) obtaining the requested protected object, the obtainment performed by the security server;
d) combining the requested protected object with the security policy, object controls, and mobile code;
e) sending the requested protected object combined with the security policy, object controls, and mobile code to the requestor device; and
f) executing the mobile code at the requester device when the mobile code is received at the requester device, wherein the mobile code instantiates the security policy and the object controls at the requester device such that the requested protected object is accessed in accordance with the security policy.

24. The method of claim 23 further defined by the security server obtaining the requested protected object from the object server.

25. The method of claim 23 further defined by the security server obtaining the requested protected object from a local cache.

26. The method of claim 23 further defined by the security server obtaining the requested protected object from a local file server.

27. The method of claim 23 further defined by the security server obtaining the security policy for the requested protected object from a local database.

28. The method of claim 23 further defined by encrypting the requested protected object at the security server.

29. The method of claim 24 further defined by redirecting an enhanced request created by the object server, the enhanced request being a second object including at least one of the following:
a) cryptographically protected authentication of the original request for the protected object;
b) cryptographically protected time of the original request for the requested object;
c) cryptographically protected serialization of the requested object; and
d) cryptographically protected security policy for the requested object.

30. The method of claim 23 further including providing a decryption key to the requester device.

31. The method of claim 23 further defined by providing and protecting a record of requested actions and actions taken on protected objects by:
a) recording to a logfile information about events, the logfile stored on the security server, the events selected from a group consisting of:
i) requests for action on the requested protected object initiated by the requester device;
ii) actions taken on the requested protected object at the requester device;
iii) actions taken by the security server relating to protection of the requested protected object, wherein the information about the event that is recorded is at least one of the following:
A) local data;
B) time of the event;
C) a network IP address of the requester device initiating the event;
D) a descriptor of the event; and
E) a request sent to the security server; and
b) providing an authorized user access to the logfile.

32. The method of claim 31 further defined by providing object controls for a protected object instantiated on the requester device, said object controls denying an attempted action on a protected object at the requester device when the requester device is not in network communication with the security server.

33. The method of claim 31 further defined by providing object controls for a protected object instantiated on the requester device, said object controls attempting to establish a connection between the requester device and the security server when the requester device is not in network communication with the security server and the requestor device attempts an action on the protected object.

34. The method of claim 31 further defined by encrypting the information sent by the requester device to the security server.

35. The method of claim 31 further defined by creating an audit trail with the logfile.

36. The method of claim 31 further defined by recording in a file any actions on a protected object on an untethered requester device and sending the file to the security server when the requestor device establishes a network connection to the security server.

37. The method of claim 31 further defined by restricting views of the logfile.

38. The method of claim 23 further defined by designating at least one object stored at an object server to receive protection.

39. The method of claim 38 further defined by determining a security policy for each protected object.

40. The method of claim 23 further defined by:
a) receiving at the security server a notification from a sending device, said notification specifying at least one protected object stored at the object server to be accessible by at least one requester;
b) generating a URL for each object to be accessed, said URL corresponding to the at least one object stored at the object server; and
c) sending an e-mail message to the at least one requestor indicating the at least one object may be accessed, said message containing the URL for each object to be accessed, wherein referencing the URL requests the at least one protected object from the object server.

41. The method of claim 40 further defined by authenticating the notification from the sending device.

42. The method of claim 23 further defined by receiving at the requester device a message from an object server indicating that at least one object stored at the object server may be accessed by the requester device.
